(19) United States
(12) Patent Application Publication
(10) Pub. No.: US 2026/0175267 A1
(43) Pub. Date: Jun. 25, 2026

(54) STATION FOR RINSING AND DRYING AT LEAST ONE FOOT OF A USER

(71) Applicant: HPH FRANCE, BESCAT (FR)

(72) Inventor: Hervé LARROQUETTE, BESCAT (FR)

(21) Appl. No.: 18/855,678

(22) PCT Filed: Apr. 5, 2023
(86) PCT No.: PCT/EP2023/059012

§ 371 Date: Oct. 10, 2024

(30) Foreign Application Priority Data
Apr. 13, 2022 (FR) FR2203397

(51) Int. Cl. B08B 3/04; B08B 3/02

(52) U.S. Cl. CPC B08B 3/04; B08B 3/02; B08B 3/022

(57) ABSTRACT

A station for rinsing and drying at least one foot of a user, comprising: an opening at a small distance from the ground, which is dimensioned so as to allow at least one foot of a user to pass through and is defined by at least two edges positioned approximately in a first plane that forms an angle of greater than 30° with the ground; a rinsing device comprising at least one pair of first and second rinsing nozzles which are configured to spray a stream of water; a drying device comprising at least one pair of first and second drying nozzles which are configured to eject a stream of air; the rinsing and drying nozzles being positioned at the edges so as to clean and dry all the surfaces of the foot when the foot passes through the opening.

### CROSS-REFERENCES TO RELATED APPLICATIONS

This application is a national phase of International Patent Application Number PCT/EP2023/059012 filed on Apr. 5, 2023, which claims the benefit of French Patent Application No. 2203397 filed on Apr. 13, 2022, the entire disclosures of which are incorporated herein by way of reference.

### FIELD OF THE INVENTION

The present application relates to a station for rinsing and drying at least one foot of a user, and more particularly a rinsing and drying station adapted to be arranged in the surroundings of a sandy beach, a swimming pool or again a games area or a sports field. Other applications of the present invention can be envisaged such as for example in public toilets, etc.

### BACKGROUND OF THE INVENTION

The vicinities of beaches, whether at the seaside or a lakeside, are sometimes equipped with a water station that includes a shower or a faucet and enables the public to rinse all or part of the body, for example to remove sand, salt or any other deposit on the body. Although this type of water station renders numerous services, its efficacy for rinsing the feet is limited.

Indeed, it is found that it is sometimes difficult to rinse the feet conveniently by means of a simple faucet or a shower, in particular when the deposit to be rinsed off adheres strongly to the feet of the user, which is the case with fine sand for example.

With the existing solutions it is most often necessary to bend down to press the pushbutton and to attempt to obtain a sufficiently high pressure to remove the sand between the toes.

The applicant further submits that the solutions known until now are not especially aesthetic and degrade the environment. The applicant also submits that the known solutions most often generate areas that are soiled and/or flooded because of the absence of water recovery.

Furthermore, after rinsing the feet are wet and it is difficult not to get them dirty again on leaving the water station. This makes it necessary to place one's wet feet in open or closed shoes with the risk of causing fungal infections or blisters when walking because of the sometimes still adhering sand rubbing on the feet.

Also, this type of water point is rarely adapted for use by persons with reduced mobility who are not able to bend down easily to access the button, who are not able to bend down to rub off and remove sand or impurities, or who do not have the strength to balance on one foot or to raise the leg sufficiently high to rinse it well without being able to hold on so as not to fall over. This is not to mention pushbuttons that have deteriorated and are difficult to activate or that remain stuck and dispense too much water, which is wasted.

The document GB2314015 proposes a tank that has an opening at the top through which a foot to be cleaned is introduced. This opening is at a distance from the ground. This tank is equipped with a multitude of water jets positioned at the periphery of the opening and oriented toward the center and the bottom of the tank. The tank is further equipped with two drying nozzles positioned at the front of the tank and oriented in such a manner as to blow air toward the back and the bottom. This is unsatisfactory because it is necessary to raise the foot to a certain height to pass it over the rim of the tank in order to introduce it into the tank via the opening. Another disadvantage is that the drying of the foot is unsatisfactory.

The document US2010/0043137 proposes a solution close to that described in the document GB2314015. According to this document US2010/0043137 a device for rinsing and drying a foot comprises a tank with an opening at the top via which a foot to be cleaned is introduced, a faucet positioned above the tank to rinse the foot and a drying nozzle positioned at the front of the tank and oriented in such a manner as to blow air toward the back. This embodiment has the same disadvantages as that described in the document GB2314015.

The document CN213001337 proposes a device for rinsing and drying a foot including a rinsing enclosure and a drying compartment separate from the rinsing device. The rinsing enclosure includes an opening offset upward for introducing the foot. This arrangement is not practical because it is necessary to raise the foot to a relatively great height to introduce it into the rinsing enclosure. Furthermore, the drying compartment being offset relative to the rinsing enclosure, it is not easy for a user to keep their balance between removing the foot from the rinsing enclosure and its introduction into the drying compartment. In one embodiment the drying compartment includes an opening through which the foot is introduced and an air nozzle positioned on one side of the compartment and oriented in such a manner as to blow air onto only one side of the foot. Consequently, drying is unsatisfactory.

### SUMMARY OF THE INVENTION

The present invention aims to remedy some or all of the disadvantages of the prior art.

To this end the invention has for objective proposing a station for rinsing and drying at least one foot of a user that is ergonomic and hygienic and enables both effective rinsing and drying of the feet in a comfortable and safe position, in the shortest possible time and limiting the waste of water.

This objective along with others that will become apparent on reading the following description is achieved by a station for rinsing and drying at least one foot of a user that includes:
a rinsing area positioned at ground level and sized to contain at least one foot of a user,
at least one structure mounted on the rinsing area, a rinsing device including at least one pair of rinsing nozzles comprising first and second rinsing nozzles configured to project a flow of water respectively in first and second flow of water directions,
a drying device including at least one pair of drying nozzles comprising first and second drying nozzles configured to project a flow of air respectively in first and second flow of air directions.

According to the invention the structure includes an opening delimited by at least two edges positioned approximately in a first plane forming an angle greater than 30° with the rinsing area and on either side of a second plane, the opening being sized to allow the passage of at least one foot of a user and at a short distance from the rinsing area. Furthermore, the first rinsing and drying nozzles are positioned at the level of the first edge of the opening and the second rinsing and drying nozzles are positioned at the level of the second edge of the opening, the first and second flow of water and flow of air directions forming with the first plane an angle less than 60°, the first flow of air and flow of water directions having a component in the direction of the second edge, the second flow of air and flow of water directions having a component in the direction of the first edge.

In this arrangement the disposition of the rinsing and drying nozzles at the level of the opening makes it possible to clean and dry all surfaces of the foot when the latter passes through the opening. Furthermore, the positioning of the opening makes the station more ergonomic.

### BRIEF DESCRIPTION OF THE DRAWINGS

Other features and advantages will emerge from the following description of the invention given by way of example only with reference to the appended drawings, in which:

FIG. 1 is a perspective view of a rinsing and drying station depicting one embodiment of the invention.

FIG. 2 is a front view of the rinsing and drying station seen in FIG. 1.

FIG. 3 is a perspective view of the rinsing and drying station seen in FIG. 1 during use by a user.

FIG. 4 is a view in longitudinal section taken along the line 4-4 in FIG. 2.

### DETAILED DESCRIPTION OF THE PREFERRED EMBODIMENTS

In the description and the claims the terms longitudinal, vertical and transverse with reference to the trihedron L, V, T indicated in the figures will be adopted in a non-limiting manner, assuming that the rinsing station is on horizontal ground.

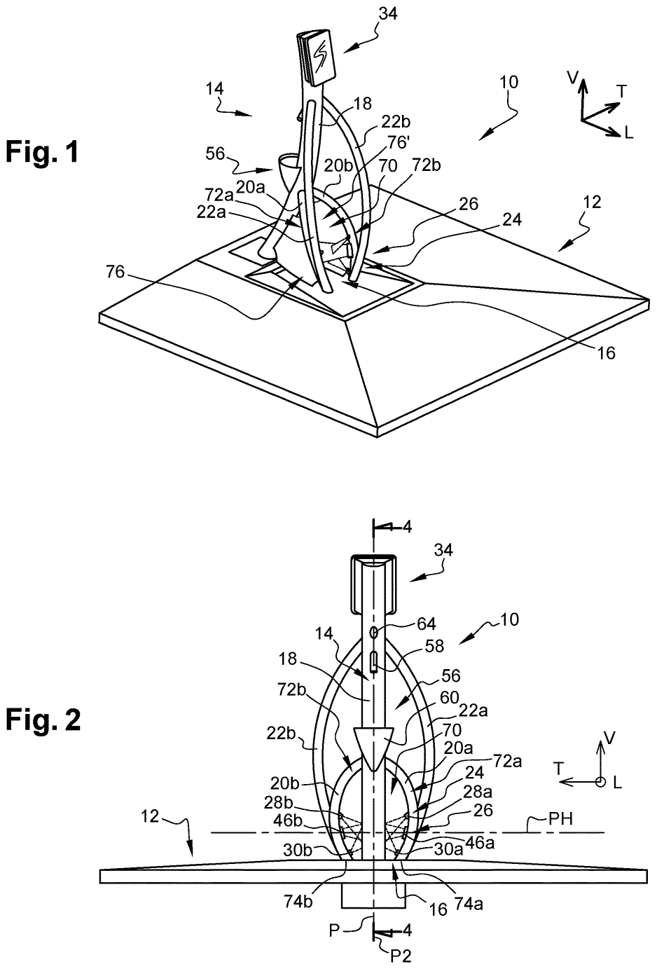

Also, the expressions “top” and “bottom” will be used in a non-limiting manner with reference to the upper part and the lower part respectively of FIG. 1.

In all these figures identical or similar elements are identified by identical reference signs and distinguished by the letters “a” and “b”.

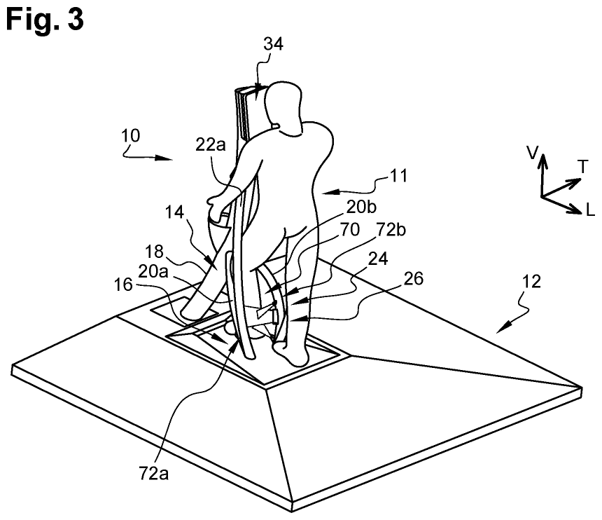

A station 10 for rinsing and drying at least one foot of a user 11 seen in FIG. 3 is represented in FIG. 1. The station 10 includes a platform 12 and a structure 14 that is rigidly attached to the platform 12.

The platform 12 is designed to be anchored on plane and preferably horizontal ground. Also, the platform 12 includes an area 16 for rinsing the feet of the user 11. Furthermore, the platform 12 is designed to be substantially flush with the ground on which it rests to favor access by persons with reduced mobility.

It will also be noted that to limit the arrival of sand or other particles in the rinsing area 16 the platform 12 is sufficiently extensive and that the rinsing area 16 is substantially at the center of the platform 12.

The structure 14 of the station 10 includes a column 18 that extends globally vertically from the platform 12. Furthermore, the structure 14 includes a first pair of arms comprising a first arm 20a and a second arm 20b that extend from the platform 12 to a median section of the column 18 and a second pair of arms comprising a third arm 22a and a fourth arm 22b that extend from the platform 12 to an upper section of the column 18.

The first pair of arms 20a, 20b and the second pair of arms 22a, 22b increase the mechanical strength of the column 18 by connecting it to the platform 12. Also, the first pair of arms 20a, 20b, the second pair of arms 22a, 22b and the column 18 are tubular, to allow the passage of pipes and cables as described hereinafter. Furthermore, the second pair of arms 22a, 22b forms a pair of handles that enable the user 11 to hold on so as not to lose their balance. It will be noted that the general design of the station 10 is symmetrical about a plane P of vertical and longitudinal symmetry represented in FIG. 2.

The station 10 includes a rinsing device 24 and a drying device 26 for rinsing and drying the feet of the user 11.

Referring to FIGS. 2 and 3 the rinsing device 24 includes a first rinsing nozzle 28a that is oriented toward the rinsing area 16, that is to say globally downward in the direction of the platform 12, to spray water onto the top of a foot or the feet of the user 11. Furthermore, the rinsing device 24 includes a second rinsing nozzle 30a that is oriented globally upward, away from the platform 12, so as to spray water onto the bottom of a foot of the user 11 when the foot of the user 11 is lifted off the rinsing area 16. By virtue of its symmetry about the plane P of symmetry the rinsing device 24 includes a third rinsing nozzle 28b transversely opposite the first rinsing nozzle 28a and a fourth rinsing nozzle 30b transversely opposite the second rinsing nozzle 30a.

Thus the first rinsing nozzle 28a and the second rinsing nozzle 30a are arranged so as to rinse a first side of the foot of the user 11 and the third rinsing nozzle 28b and the fourth rinsing nozzle 30b are arranged so as to rinse an opposite second side of the foot of the user 11.

Referring to FIG. 2 the first rinsing nozzle 28a and the second rinsing nozzle 30a are mounted on the first arm 20a of the structure 14. By virtue of their symmetry the third rinsing nozzle 28b and the fourth rinsing nozzle 30b are mounted on the opposite second arm 20b of the structure 14.

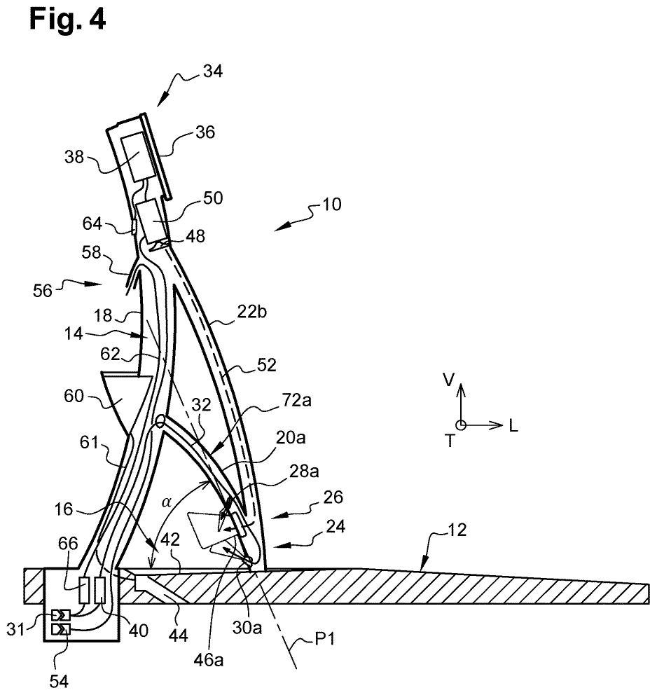

As can be seen in FIG. 4 the station 10 is connected to a source 31 of water under pressure that feeds the rinsing nozzles 28a, 30a, 28b, 30b with water via a first feed pipe 32 represented schematically in FIG. 4. The first feed pipe 32 extends inside the tubular structure 14. In a non-limiting manner the rinsing station 10 may be equipped with a compressor designed to increase the pressure of the water that flows through the rinsing nozzles 28a, 30a, 28b, 30b to increase the efficacy of rinsing. In a complementary manner the rinsing station 10 is equipped with a control device 34 that includes a touch screen 36 designed to enable the user 11 to activate the rinsing nozzles 28a, 30a, 28b, 30b.

This touch screen 36 can equally serve as a communication and information means for providing information to its user (meteorological data, tourist information, etc.).

To this end the control device 34 includes an electronic control unit 38 that cooperates with the touch screen 36 and controls a first solenoid valve 40 mounted on the first water feed pipe 32. In a non-limiting manner the first solenoid valve 40 may more particularly be controlled by the detection of the presence of a foot by means of an appropriate sensor (not represented). In addition to detecting the presence of a foot this sensor is also designed to determine and to analyze the quantity of sand on the foot and to adapt washing accordingly.

For example image processing will be used to evaluate a quantity of sand and to generate a control signal to trigger washing using a calculated quantity of water. To favor the evacuation of the rinsing water the rinsing area 16 forms a tray 42 that is equipped with a pipe 44 for evacuation of used rinsing water.

Referring to FIGS. 2 and 3 the drying device 26 includes a first drying nozzle 46a that is designed to blow air toward the rinsing area 16, onto the foot of the user 11. The first drying nozzle 46a is mounted on the first arm 20a of the structure 14 and is for example disposed between the first rinsing nozzle 28a and the second rinsing nozzle 30a. By virtue of its symmetry about the plane P of symmetry the drying device 26 includes a second drying nozzle 46b that is transversely opposite the first drying nozzle 46a. Thus the first drying nozzle 46a is oriented in such a manner as to favor the drying of a first side of the foot of the user 11 and the second drying nozzle 46b is oriented in such a manner as to favor the drying of the opposite second side of the foot of the user 11.

It will be noted that the drying nozzles 46a, 46b participate in washing the feet of the user 11 by mechanical action with an efficacy that depends in particular on the power of the flow of air ejected via the drying nozzles 46a, 46b. The flow of water ejected by the rinsing nozzles 28a, 30a, 28b, 30b then acts overall as a solvent that reduces the effects of adhesion of the deposit on the feet to be washed, which makes it possible to limit the consumption of water used. Also, as can be seen in FIG. 4 the rinsing station 10 includes a blower 48 that is driven by an electric motor 50 and that feeds the drying nozzles 46a, 46b with compressed air via a pipe 52 that is represented schematically.

The blower 48 and the associated motor 50 are housed inside the tubular column 18. The touch screen 36 of the control device 34 enables the user 11 to control activation of the blower 48 to feed air to the drying nozzles 46a, 46b. It moreover enables remote broadcasting of controlled and updated messages. In a non-limiting manner activation of the blower 48 may be controlled automatically by the detection of the presence of a foot by means of an appropriate sensor (not represented). In addition to detecting the presence of a foot the sensor is also configured to determine and to analyze the quantity of sand on the foot and to adapt washing accordingly.

It will be noted that the station 10 is connected to a source of electrical energy via a connection box 54. In a non-limiting manner the station 10 may be equipped with an autonomous electricity producing device (not represented) which for example includes a photovoltaic panel (or a wind turbine) that supplies the station 10 with electricity.

Finally, as can be seen in FIG. 4, the rinsing station 10 includes a drinking fountain 56 that includes a spout 58 for drinking water and a receptacle 60 that is arranged vertically below the spout 58. The receptacle 60 is connected to the waste water evacuation pipe 44 via a tube 61 that is represented schematically in FIG. 4. The spout 58 of the drinking fountain 56 is connected to the source 31 of water via a second feed pipe 62. The drinking fountain 56 is mounted on the column 18 of the structure 14 of the station 10 longitudinally opposite the rinsing device 24 and the drying device 26 to enable the user to use the drinking fountain 56 while at the same time another user is rinsing their feet using the rinsing device 24. In a complementary manner the column 18 carries a pushbutton 64 that is associated with a second solenoid valve 66 to control the supply of water to the spout 58 of the drinking fountain 56. This spout has a limited water flowrate so as to dispense only a quantity of water programmed in the device in order not to spill and waste drinking water.

In accordance with a variant of the invention that is not represented, the rinsing nozzles 28a, 30a, 28b, 30b are designed to eject a flow of water and a flow of air simultaneously. This variant makes it possible to limit the consumption of water when rinsing the feet of the user.

In a preferred variant it is therefore possible to combine in a mix a flow of water for rinsing and a flow of air for drying. This mix is produced in the cleaning cavity via an injection manifold made up of adjacent or combined water nozzles and air curtains.

Adjustment of the flowrate and orientation of the jets makes it possible to optimize the evacuation of deposits and to limit splashing able to exit from the cavity. Note here that drying is effected by activating only the flow of air at its maximum power.

The shape of the cavity and of the jets on the foot enable optimum cleaning.

Note further that the present invention addresses constraints of mechanical bulk, internal and external seal and thermal management. Indeed, the design of the present invention addresses thermal constraints linked to heating (caused by the components and by radiation) that can put the device into a safe state and render it unavailable.

To address these constraints there may be employed an internal water/air and/or water exchanger integrated into the motor.

Alternatively (or additionally) there may also be provided a sunscreen self-cooled by natural convection over all its surfaces (e.g. wooden cladding with apertures at the top and bottom a few centimeters away from the envelope, enabling natural circulation of air).

There is equally envisaged evaporation of the rinsing water via a medium in contact with the enclosure. Some or all of the rinsing water is then captured by the medium (foam/felt) installed in the evacuation zone and rising along the enclosure of the device. This water rises up the equipment by capillary action (or in an active manner) and cools it by evaporation. Topping up with water via nozzles installed in the high part of the enclosure in the event of high temperatures may be envisaged. This active feed circuit is connected to the water feed circuit of the device and is triggered by a temperature sensor.

To limit the dispersion of water around the rinsing area 16 the rinsing and drying station 10 includes at least one wall 76. In one arrangement the station 10 includes two walls 76, 76′ (visible in FIG. 1), namely a first wall 76 that extends between the ground, the first arm 20a and the column 18 and a second wall 76′ that extends between the ground, the second arm 20b and the column 18. These first and second walls 76, 76′ can be slightly curved toward the exterior of the rinsing area 16. These first and second walls 76, 76′ are configured to orient waste water toward the tray 42 in order to collect it and possibly recycle it.

Finally, there may also be envisaged a space with plants receiving/covering the device that covers it up to the evacuation zone. This system with plants benefits from the rinsing water and enables cooling by evaporation, watering of the plants and protection from the sun. In order to optimize the consumption of water capture means (video camera, etc.) are provided for detecting the size and the shape of a foot. There are envisaged ultrasound sensors or a video camera system associated with AI software capable of using image processing algorithms to obtain the required information. These means can preferably also be configured to detect the quality and the volume of sand on the foot in order to adapt the washing and drying of the foot.

Of course, the invention is described above by way of example. It is to be understood that without departing from the scope of the invention the person skilled in the art is in a position to produce different variants of the invention. For example, the various embodiments of the invention may be combined with one another.

Whatever the embodiment, the rinsing and drying station 10 includes a rinsing area 16 positioned at ground level and sized to contain at least one foot of a user 11, at least one structure 14 mounted on the rinsing area 16, a rinsing device 24 including at least one pair of rinsing nozzles comprising first and second rinsing nozzles 28a, 28b configured to spray a flow of water in respectively first and second flow of water directions as well as a drying device 26 including at least one pair of drying nozzles comprising first and second drying nozzles 46a, 46b configured to project a flow of air in respectively first and second flow of air directions.

In accordance with the invention the structure 14 includes an opening 70 delimited by at least two edges 72a, 72b positioned approximately (i.e., +/−10%) in a first plane P1 (visible in FIG. 4), the opening 70 being sized to allow the passage of at least one foot of a user 11 and at a short distance from the rinsing area 16. By at a short distance from the rinsing area 16 is meant that the opening 70 is separated from the rinsing area 16 by a distance less than 15 cm. Also, the first plane P1 forms with the rinsing area 16 an angle α greater than 30°, less than 150°.

In one arrangement the edges 72a, 72b are positioned on either side of a second plane P2 (which may be the plane P of vertical symmetry, a horizontal plane or a plane inclined to a greater or lesser degree relative to the plane P of vertical symmetry). In one configuration the plane P2 is perpendicular to the plane P1 and intersects the opening 70.

In accordance with the invention the first rinsing and drying nozzles 28a, 46a are positioned at the level of the first edge 72a of the opening 70 and the second rinsing and drying nozzles 28b, 46b are positioned at the level of the second edge 72b, the first and second flow of water and flow of air directions forming with the first plane P1 an angle less than 60°, the first flow of air and flow of water directions having a component in the direction of the second edge 72b, the second flow of air and flow of water directions having a component in the direction of the first edge 72a.

When the foot of the user 11 passes through the opening 70 the two sides of the foot are therefore impacted simultaneously by the flows of water leaving the first and second rinsing nozzles 28a, 28b and then by the flows of air leaving the first and second drying nozzles 46a, 46b. The foot is therefore correctly cleaned and dried. The fact that the opening 70 is close to the ground and inclined facilitates the use of the station 10.

To improve the ergonomics the opening 70 intersects the rinsing area 16. With this arrangement the first and second edges 72a, 72b have first and second lower ends 74a, 74b at the level of the rinsing area 16 that are spaced from one another.

In one configuration the first plane P1 forms with the rinsing area 16 an angle between 45° and 60° inclusive. In one embodiment the first and second edges respectively correspond to the first and second arms 20a, 20b of the first pair of arms.

The first and second edges 72a, 72b are symmetrically positioned relative to the plane P of vertical symmetry.

To improve drying the first and second flow of air directions form with the first plane P1 an angle less than or equal to 10°. In a complementary manner the first and second flow of air directions form with a direction parallel to the rinsing areas 16 an angle less than or equal to 10°. The first and second nozzles 46a, 46b are positioned in a symmetrical manner relative to the plane P of vertical symmetry.

For improved cleaning the first and second flow of water directions form with the first plane P1 an angle less than or equal to 10°. In one configuration the rinsing device 24 includes first and second pairs of rinsing nozzles comprising first and second rinsing nozzles 28a, 28b, 30a, 30b, the first and second rinsing nozzles 28a, 28b of the first pair being positioned above a horizontal plane PH, producing first and second flows of water having a component oriented downward, and being intended to clean the top of the foot, the first and second nozzles 30a, 30b of the second pair being situated below the horizontal plane PH, producing first and second flows of water having a component oriented upward and being intended to clean the bottom of the foot.

The first and second rinsing nozzles 28a, 28b, 30a, 30b of each pair are positioned in a symmetrical manner relative to the plane P of vertical symmetry.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-13. (canceled)

14. A station for rinsing and drying at least one foot of a user, the station comprising:
a rinsing area positioned at ground level and sized to contain at least one foot of a user,
at least one structure mounted on the rinsing area,
a rinsing device including at least one pair of rinsing nozzles comprising a first rinsing nozzle and a second rinsing nozzle configured to project a flow of water respectively in first and second flow of water directions,
a drying device including at least one pair of drying nozzles comprising a first drying nozzle and a second drying nozzle configured to project a flow of air respectively in first and second flow of air directions,
wherein the at least one structure includes an opening delimited by at least two edges positioned approximately in a first plane forming an angle greater than 30° with the rinsing area and on either side of a second plane, the opening being sized to allow the passage of at least one foot of a user and at a short distance from the rinsing area, and
wherein the first rinsing nozzle and the first drying nozzles are positioned at a level of a first edge of the opening and the second rinsing nozzle and the second drying nozzle are positioned at a level of a second edge of the opening,
wherein the first flow of water direction, the second flow of water direction, the first flow of air direction, and the second flow of air direction forming, with the first plane, an angle less than 60°, the first flow of air direction and the first flow of water direction having a component in a direction of the second edge, the second flow of air direction and the second flow of water direction having a component in a direction of the first edge.

15. The station as claimed in claim 14, wherein the opening intersects the rinsing area.

16. The station as claimed in claim 14, wherein the first flow of air direction and the second flow of air direction forms, with the first plane, an angle less than or equal to 10°, and, with a direction parallel to the rinsing area, an angle less than or equal to 10°.

17. The station as claimed in claim 14, wherein the first flow of water direction and the second flow of water direction forms, with the first plane, an angle less than or equal to 10°.

18. The station as claimed in claim 14, wherein the rinsing device includes first and second pairs of rinsing nozzles each comprising first and second rinsing nozzles, the first and second rinsing nozzles of the first pair being positioned above a horizontal plane and producing first and second flows of water having a component oriented downward, the first and second rinsing nozzles of the second pair being positioned below the horizontal plane and producing first and second flows of water having a component oriented upward.

19. The station as claimed in claim 14, wherein the first and second edges, the first and second rinsing nozzles of each pair, and the first and second drying nozzles are positioned in a symmetrical manner relative to a plane of vertical symmetry.

20. The station as claimed in claim 19, further comprising:
a control device configured to selectively to command rinsing and drying with the first and second rinsing nozzles and the first and second drying nozzles, respectively.

21. The station as claimed in claim 14, further comprising:
a blower that is driven electrically and feeds the first and second drying nozzles with air.

22. The station as claimed in claim 14, further comprising:
a drinking fountain having a water spout and a waste water receptacle, the drinking fountain mounted on the at least one structure of the station.

23. The station as claimed in claim 14, wherein the at least one structure includes a column that extends from a platform and at least one pair of arms comprising first and second arms each of which extends from the platform to said column, the first arm corresponding to the first edge, the second arm corresponding to the second edge.

24. The station as claimed in claim 23, further comprising:
a first wall that extends between the ground, the first arm, and the column; and
a second wall that extends between the ground, the second arm, and the column.

25. The station as claimed in claim 23, wherein the at least one structure includes a second pair of arms comprising a third arm and a fourth arm that extend from the platform to an upper section of the column and form a pair of handles.

26. The station as claimed in claim 25, wherein the at least one structure is tubular to allow pipes and cables to pass through said structure.
